(19) United States
(12) Patent Application Publication
(10) Pub. No.: US 2026/0300015 A1
(43) Pub. Date: Oct. 1, 2026

(54) SYSTEMS AND METHODS FOR SELECTING AN ENVIRONMENT FOR EXECUTING AN ARTIFICIAL INTELLIGENCE TASK

(71) Applicant: Samsung Electronics Co., Ltd., Suwon-si (KR)

(72) Inventors: Matthew S. Bryson, Los Gatos, CA (US); Ho Bin Lee, San Jose, CA (US); Rekha Pitchumani, Oak Hill, VA (US)

(21) Appl. No.: 19/273,773

(22) Filed: Jul. 18, 2025

Related U.S. Application Data
(60) Provisional application No. 63/781,251, filed on Mar. 31, 2025.

(51) Int. Cl. G06F 9/50

(52) U.S. Cl. CPC G06F 9/5027

(57) ABSTRACT

A system comprising a processing circuit; and a memory storing instructions, which, based on being executed by the processing circuit, cause the processing circuit to perform: receiving, on a first device, a first request to perform a first artificial intelligence (AI) task; determining a first set of characteristics based on the first request; performing the AI task on the first device based on determining the first set of characteristics; receiving, on the first device, a second request to perform a second AI task; determining a second set of characteristics based on the second request; and based on determining the second set of characteristics, transmitting by the first device to a second device communicatively coupled to the first device, information on the second AI task to signal the second device to perform the second AI task.

### CROSS-REFERENCE TO RELATED APPLICATION(S)

The present application claims priority to and the benefit of U.S. Provisional Application No. 63/781,251, filed Mar. 31, 2025, entitled “LOCAL ARTIFICIAL INTELLIGENCE (AI) DISCRIMINATOR,” the entire content of which is incorporated herein by reference.

### FIELD

One or more aspects of embodiments according to the present disclosure relate to selecting an environment for executing an artificial intelligence model.

### BACKGROUND

The use of artificial intelligence (AI) has increased dramatically over the last few years. AI has become commonly used in domains such as image classification, speech recognition, media analytics, heath care, autonomous machines, smart assistants, etc. Using AI often necessitates the use of large datasets (e.g., from databases, sensors, images etc.) and the use of advanced algorithms that similarly necessitate efficient high-performance computing and data processing solutions.

The above information disclosed in this Background section is only for enhancement of understanding of the background of the present disclosure, and therefore, it may contain information that does not form prior art.

### SUMMARY

According to some embodiments of the present disclosure, a method comprises: receiving, at a first computing environment, a request to perform an artificial intelligence (AI) task; selecting at least one computing environment from one or more computing environments for performing the AI task based on a set of characteristics associated with the AI task; and transmitting a command to the at least one selected computing environment to perform the AI task.

In some embodiments, the one or more computing environments comprises the first computing environment and a second computing environment remote from the first computing environment, wherein the first computing environment is a local device and the second computing environment is a remote device.

In some embodiments, the set of characteristics associated with the AI task include at least one of a maximum latency, an amount of computational resource, an amount of memory, or an amount power associated with performing the AI task.

In some embodiments, the set of characteristics include at least one of a computational availability, a memory availability, a power availability, a latency, a network connectivity status, a security specification, or a hardware specification of the first computing environment.

According to some embodiments of the present disclosure, a method comprises: receiving, on a first device, a first request to perform a first artificial intelligence (AI) task; determining a first set of characteristics based on the first request; performing the AI task on the first device based on determining the first set of characteristics; receiving, on the first device, a second request to perform a second AI task; determining a second set of characteristics based on the second request; and based on determining the second set of characteristics, transmitting by the first device to a second device communicatively coupled to the first device, information on the second AI task to signal the second device to perform the second AI task.

In some embodiments, the first set of characteristics includes one or more characteristics of the first AI task and the second set of characteristics includes one or more characteristics of the second AI task.

In some embodiments, the first set of characteristics include parameters associated with at least one of a maximum latency, an amount of computational resource, an amount of memory, or an amount power associated with performing the first AI task.

In some embodiments, wherein the first set of characteristics and the second set of characteristics include one or more characteristics of the first device.

In some embodiments, the one or more characteristics of the first device include at least one of a computational availability, memory availability, power availability, latency, network connectivity status, security specification, or hardware specification.

In some embodiments, performing the first AI task on the first device includes invoking an AI model in the first device.

In some embodiments, the method further comprises selecting, using a deterministic algorithm, the first device to perform the first AI task.

In some embodiments, the method further comprises selecting, using a machine learning (ML) model, the first device to perform the first AI task.

According to some embodiments of the present disclosure, a system comprises: a processing circuit; and a memory storing instructions, which, based on being executed by the processing circuit, cause the processing circuit to perform: receiving, on a first device, a first request to perform a first artificial intelligence (AI) task; determining a first set of characteristics based on the first request; performing the AI task on the first device based on determining the first set of characteristics; receiving, on the first device, a second request to perform a second AI task; determining a second set of characteristics based on the second request; and based on determining the second set of characteristics, transmitting by the first device to a second device communicatively coupled to the first device, information on the second AI task to signal the second device to perform the second AI task.

In some embodiments, the first set of characteristics includes one or more characteristics of the first AI task and the second set of characteristics includes one or more characteristics of the second AI task.

In some embodiments, the first set of characteristics include parameters associated with at least one of a maximum latency, an amount of computational resource, an amount of memory, or an amount power associated with performing the first AI task.

In some embodiments, the first set of characteristics and the second set of characteristics include one or more characteristics of the first device.

In some embodiments, the one or more characteristics of the first device include at least one of a computational availability, memory availability, power availability, latency, network connectivity status, security specification, or hardware specification.

In some embodiments, performing the first AI task on the first device includes invoking an AI model in the first device.

In some embodiments, the instructions, based on being executed by the processing circuit, further cause the processing circuit to perform: selecting, using a deterministic algorithm, the first device to perform the first AI task.

In some embodiments, the instructions, based on being executed by the processing circuit, further cause the processing circuit to perform: selecting, using a machine learning (ML) model, the first device to perform the first AI task.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a block diagram of a system for selecting an environment for executing an artificial intelligence (AI) model, according to one or more embodiments.

FIG. 2 depicts a diagram for handling a model inference request using an AI-based classifier, according to one or more embodiments.

FIG. 3 depicts a diagram for handling a model inference request using a deterministic algorithm, according to one or more embodiments.

FIG. 4 depicts a flow diagram of a process for selecting an environment for executing an AI task, according to one or more embodiments.

FIG. 5 depicts a flow diagram of a process for training or updating an ML-based classifier, according to one or more embodiments.

FIG. 6 depicts a flow diagram of an example process for handling requests to perform an AI task, according to one or more embodiments.

FIG. 7 depicts a flow diagram of another example process for handling a request to perform an AI task, according to one or more embodiments.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

In addition, a feature of embodiments of the present disclosure may be combined or combined with one or more other features, partially or entirely, and may be operated in various ways, and an embodiment may be implemented independently of one or more other embodiments, or in conjunction with the one or more other embodiments.

Personal devices such as smartphones and personal computers are becoming more capable of running artificial intelligence (AI) tasks, including machine learning (ML) tasks (used interchangeably herein), including image recognition and natural language processing, locally. This may be driven by advances in hardware acceleration, such as mobile graphics processing units (GPUs), neural processing units (NPUs), and optimized AI runtimes like Core ML, TensorFlow Lite, and ONNX Runtime. Running models locally may reduce latency, improve privacy, and enable offline functionality.

However, running an AI model or task locally (e.g., on a personal device) may not always result in the best performance or overall user experience. A local device, such as a smartphone, may still be subject to certain limitations that may affect its performance. For example, a smartphone typically operates on battery and the AI task may require power that exceeds the currently available or allotted power. However, when the smartphone is fully charged or plugged into a power source, the available power may be adequate for performing the AI task. A local device also has limited memory and/or processing availability, and there may not enough available memory compared to the memory and processing required to perform the AI task. There may be other factors, such as latency, that affect whether an AI task can be adequately performed at a local device. A server device may have fewer limitations and varying conditions compared to a local device. Thus, it may sometimes be more advantageous to run an AI task remotely on a server device rather than on a local device.

The present disclosure provides systems and methods for selecting an environment (e.g., a local or remote device) for executing an AI or ML task or model (used interchangeably herein). In some embodiments, when a request to perform an AI task is received at a local device, one or more characteristics of the AI task and one or more characteristics of the local device are determined (e.g., computed, received, or obtained). For example, characteristics of the AI task may include a model size, a weight size, an input size, a latency requirement, a computational requirement, a memory requirement, and/or an energy requirement, among others. Characteristics of the AI task may also be referred to as requested resources. One or more characteristics of the local device may include memory availability, power availability, computational availability, latency, network connectivity status, security specifications, and/or hardware specifications, among others. Characteristics of the local device may also be referred to as available resources.

In some embodiments, an environment selector receives the request to perform the AI task and compares the characteristics of the local device (e.g., available resources of the local device) against the characteristics of the AI task (e.g., requested resources of the AI task) to determine whether the AI task can be adequately performed at the local device or if the AI task should be performed at a remote device (e.g., server, desktop computer, and/or the like). The environment selector may be implemented using heuristics or decision-making strategies or algorithms that may not invoke learning. In some embodiments, the environment selector is implemented as an AI model such as a classifier that may call for classifier training and learning. In one or more embodiments, a determination or prediction is made as to whether to perform the AI task at the local device or at the remote device based on the characteristics of the AI task and the characteristics of the local device.

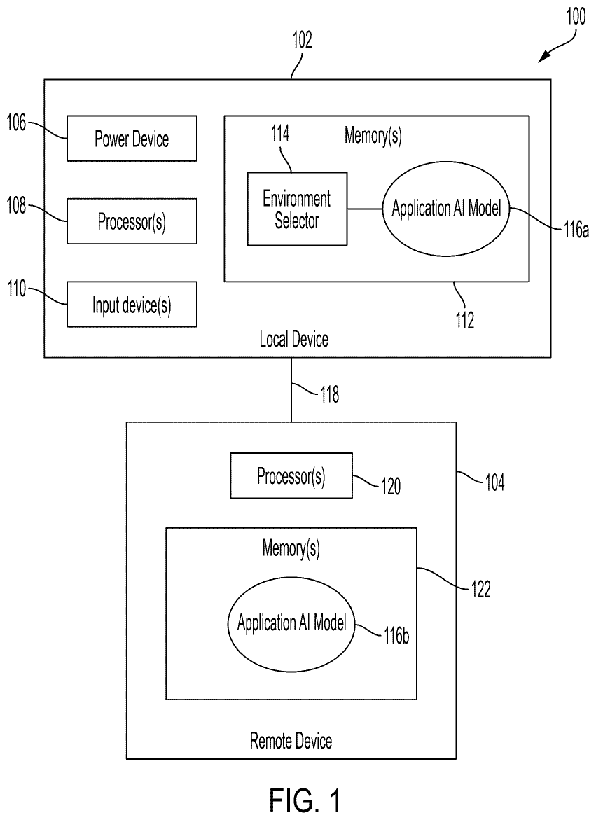

FIG. 1 depicts a block diagram of a system 100 for selecting an environment for executing an artificial intelligence (AI) model, according to one or more embodiments. The system includes a local device 102 and a remote device 104. In some embodiments, the local device 102 is a device at which a request to perform an AI task is received. The AI task may be a training task or an inference task. Examples of the local device 102 includes smartphones, tablets, laptops, desktop computers, e-readers, video game consoles, smart televisions, AI home assistants, smart vehicle systems, wearable devices such as smartwatches, fitness trackers, health monitors, among many others.

In some embodiments, the local device 102 includes a power source 106, one or more processors 108, one or more input devices 110, and one or more memory devices 112. The power source 106 supplies, stores, or regulates electrical power to the local device 102. In some embodiments, such as in which the local device 102 is a portable device like a smartphone or laptop, the power source 106 includes a battery such as a lithium-ion battery. The power source 106 may also include a power adapter or charger which supplies power from an outlet to the battery. In some embodiments, such in which the local device 102 is a desktop computer, the power source 106 includes a power supply unit which converts alternating current (AC) power from an output to direct current (DC) power for use by the device.

The one or more processors 108 may include circuitry such as one or more central processing units (CPUs), graphics processing units (GPUs), neural processing units (NPUs), tensor processing units (TPUs), microcontrollers, digital signal processors (DSPs), application-specific integrated circuits (ASICs), field programmable gate arrays (FPGAs), hard-wired logic, and/or analog circuitry.

The one or more memory devices 112 may include one or more volatile and/or nonvolatile memory devices, such as, for example, a high-bandwidth memory (HBM), a dynamic random access memory (DRAM), a static random access memory (SRAM), a NAND flash memory, a low-power double data rate (LPDDR) memory, a compute express link (CXL) memory, and/or the like. In some embodiments, the one or more memory devices 112 may store instructions and data that allow the one or more processors 108 to execute an application AI model 116a and an environment selector 114.

The one or more input devices 110 may allow a user or other system/device to provide an input to the application AI model 116a. The input may include a query, command, or data. The one or more input devices 110 may include user interfacing inputs such as a keyboard, mouse, touchscreen, physical buttons, microphone, camera, video game controllers, among others. The one or more input devices 110 may also include sensors that provide data such as accelerometers, gyroscopes, global position system (GPS) devices, fingerprint scanners, and heart rate sensors, among others.

The remote device 104 may be a device that is physically and/or geographically separate from the local device. In some embodiments, the remote device 104 is a remote server such as a cloud server. In some embodiments, the remote device 104 is a laptop computer or personal desktop computer.

The remote device 104 may be coupled to the local device 102 over a data communications link 118. The data communications link 118 may include, for example, a compute express link (CXL) bus, peripheral component interconnect express (PCIe) bus, Ethernet, Universal Serial Bus (USB), and/or any wired or wireless data communication link or network (e.g., a local area network, wide area network, and/or the public Internet).

The remote device 104 may be configured to execute the AI task received at the local device 102, to perform the training or inference requested by the AI task. In this regard, the AI task may be offloaded or transmitted by the receiving local device 102 to the remote device 104 based on determining the characteristics associated with the request, which may include characteristics of the local device and/or the AI task. In some embodiments, characteristics of the AI task includes characteristics of the AI model and/or characteristics of the input. In some embodiments, the local device 102 offloads or transmits the AI task to the remote device 104 over the data communications link 118. In some embodiments, the remote device 104 uses the data communications link 118 to send results of the execution of the AI task back to the local device 102. In some embodiments, compared to the local device 102, the remote device 104 has higher computational and/or memory capacity and fewer resource limitations such as power. However, this may not be the case in all embodiments.

The remote device 104 includes one or more processors 120 and one or more memory devices 122. The one or more processors 120 may include circuitry such as one or more central processing units (CPUs), graphics processing units (GPUs), tensor processing units (TPUs), microcontrollers, digital signal processors (DSPs), application-specific integrated circuits (ASICs), field programmable gate arrays (FPGAs), hard-wired logic, and/or analog circuitry.

The one or more memory devices 122 may include one or more volatile and/or nonvolatile memory devices, such as, for example, a high-bandwidth memory (HBM), a dynamic random access memory (DRAM), a static random access memory (SRAM), a NAND flash memory, a low-power double data rate (LPDDR) memory, a compute express link (CXL) memory, and/or the like. In some embodiments, the one or more memory devices 122 may store instructions and data that allow the one or more processors 120 to execute an application AI model 116b. In some embodiments, the application AI model 116b in the remote device 104 is the same as the application AI model 116a in the local device 102. In some embodiments, the application AI model 116b in the remote device 104 is a different from the application AI model 116a in the local device 102, but accomplishes the same or similar task such that the two can be used interchangeably.

The application AI model 116a and 116b (collectively referenced as 116) may include one or more AI models for one or more types of applications running on the local device 102, such as device-native applications or third-party applications accessed via a downloaded software package. For example, the application AI model 116 may include natural language processing (NLP) models, such as bidirectional encoder representations from transformers (BERT) and generative pre-trained transformer (GPT) which may be used for applications like chat-bots, text-prediction, auto-correction, language translation, and the like. In some embodiments, the application AI model 116 may include a computer vision model, such as convolutional neural network (CNN), which can analyze and interpret visual data such as images and video. The computer vision model may enable facial recognition, image enhancements for photos, real-time filters for camera applications, photo categorization, object detection, augmented reality features, among others. In some embodiments, the application AI model 116 includes a speech recognition model that converts spoken language into text and which may be used in voice typing, voice search, voice assistants, and translations, among others. In some embodiments, the application AI model 116 includes collaborative filtering and matrix factorization techniques for content recommendations. In some embodiments, the application AI model 116 includes predictive models and classifiers, such as based on decision trees, support vector machines, or neural networks, for email spam detection, health monitoring through wearables, image classification, content filters, and the like. In some embodiments, the application AI model 116 includes generative models, such as generative adversarial (GAN) models and diffusion models, for generating new images, audio, or video from user inputs.

In some embodiments, the environment selector 114 of the local device 102 is configured to receive an input command and identify an application AI model 116 based on the input command. The input command may identify an AI task (e.g., text prediction/generation, image prediction/generation, speech recognition, and/or another task performed by the application AI model 116). In some embodiments, the environment selector 114 is configured to determine, based on the characteristics of the application AI model 116 (e.g., model name, number of parameters in the model, model size, model weight size, the size of an input (e.g., query) to the model, number of layers of the model, number of nodes/operations, types of operations, memory utilized, acceptable latency, computation resource consumption) and/or the characteristics of the local device 102, whether to run the application AI model 116a at the local device 102 or to offload the AI task to the remote device 104 for processing the AI task via the application AI model 116b at the remote device 104.

Characteristics of the AI model 116 that are considered by the environment selector 114 may include model name, number of parameters in the model, model size, model weight size, the size of an input (e.g., query) to the model, number of layers of the model, number of nodes/operations, types of operations, memory utilized, acceptable latency, computation resource consumption, among others.

Characteristics of the local device 102 that are considered may include available battery power, available memory, available bandwidth, processor utilization (e.g., how much of the processor's 108 capacity is currently being used), number of free cores or threads, computational speed, network connectivity status, datatypes supported by the processor 108 (e.g., NPU), and additional hardware (e.g., processor, memory, accelerator) specifications. Characteristics of the local device 102 that are considered may also include user preferences or device settings such as privacy settings, data caps, whether to allow certain data transfers using cellular data when wi-fi is not available, data transfer cost, roaming status, among others.

In some embodiments, characteristics of the remote device 104 are also considered by the environment selector 114. Characteristics of the remote device 104 that are considered may include memory 122 availability, processor 120 constraints (e.g. how much of the processor's 120 capacity is currently being used, number of free cores or threads, computational speed), datatypes supported by the processor 120 (e.g., NPU), and additional hardware (e.g., processor, memory, accelerator) types and specifications. In some embodiments, characteristics of the local device 102 and/or remote device 104 that are considered also include bandwidth limitations for transmitting inference input and output between the local device 102 and the remote device 104.

In some embodiments, the environment selector 114 is implemented by the processor 108 based on instructions and parameters stored in memory device 112. In some embodiments, the environment selector 114 includes an ML-based model, such as a classifier. In such embodiments, the characteristics of the application AI model 116 and/or characteristics of the local device 102 are converted to an embedding vector. The embedding vector may be input to a classifier model of the environment selector 114, to classify the input data as fit for the local device 102 or the remote device 104 based on the embedding vector. In some embodiments, the classifier may be trained using labeled training data, in which each training input (e.g., set of application AI model 116 characteristics and/or local device 102 characteristics) is labeled with the correct classification output (e.g., local device 102 or remote device 104).

In some embodiments, the classifier model may output more than two classifications or classes. For example, a portion of the AI task may be run locally, and a portion of the AI task may be run remotely. In some embodiments, the classifier may be trained or updated without explicitly labeled training data. Rather, the classifier may be trained or reinforced based on internal evaluation metrics such as a perform outcome of a decision to run an AI task locally or remotely. For example, if an AI task is run remotely given a certain set of application AI model 116 characteristics and/or local device 102 characteristics, and the performance outcome indicates that there was not enough memory to perform the AI task or that the latency was higher than average or higher than an acceptable threshold, the performance outcome would indicate that the classification was wrong and act as a negative example or data point.

In some embodiments, the environment selector 114 includes a deterministic model or non-ML based heuristic including, for example, decision logic (e.g., a set of decision rules) or algorithm to determine whether to execute the AI task locally at the local device 102 or to execute the AI task remotely at the remote device 104. The deterministic model or non-ML-based heuristic may be generated based on historical analysis of AI tasks performed at the local device and/or remote device, the characteristics of the AI task and the local device 102, and performance outcome in performing such tasks via the local device or remote device 104.

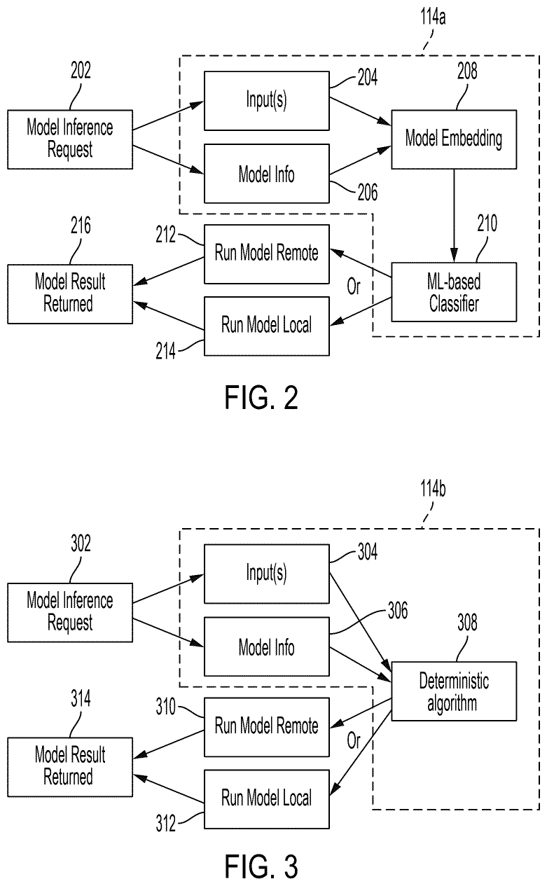

FIG. 2 depicts a data flow diagram for handling a model inference request via an environment selector 114a that uses an ML-based classifier, according to one or more embodiments. The environment selector 114a may receive a request to perform an AI task (e.g., model inference or training request) 202 for an application AI model 116. The environment selector 114a may process the request 202 and identify one or more inputs 204 and model information 206 pertaining to the application AI model 116. Depending on the application, the one or more inputs 204 may include a query, such as a text prompt or question for a natural language processing application, images or video for an image analysis or computer vision application, audio inputs such as voice commands or recorded speech for a speech recognition and sound classification application, sensor data devices like accelerometers, temperature sensors, or heart rate monitors, or a data-based application for tabular data such as spreadsheets or databases, among many other types of inputs 204 that may be utilized for inference using an application AI model 116. In some embodiments, the model inference request 202 is received at the local device 102.

The model information 206 may include characteristics of the application AI model 116, such as model name or identifier, number of parameters in the model, model size, model weight size, the size of an input (e.g., query) to the model, number of layers, number of nodes/operations, types of operations, memory utilized, acceptable latency, computation resource consumption, among others. In some embodiments, the environment selector 114a derives or retrieves the model information 206 (e.g., from the memory device(s) 112) based on the input 204.

In some embodiments, the inputs 204 and the model information 206 are used to generate a model embedding 208 including a representation of the inputs 204 and the model information 206 in an embedding space. For example, the model embedding 208 may be a vector having numerical elements that represent the combination of the inputs 204 and the model information 206. In some embodiments, the embedding may be of a fixed size that represents the data type and length. In some embodiments, the model embedding 208 is generated by the environment selector 114a at the local device 102.

In some embodiments, the model embedding 208 is provided to an ML-based classifier 210. The ML-based classifier 210 may select the local device 102 or the remote device 104 based on the model embedding 208 to execute the AI model 116. In the event that the remote device 104 is selected, the environment selector 114a may transmit a signal or command to the remote device to run the AI model 116b in the remote device. All or some of the model inference request 202 (e.g., the inputs 204) may be included in the signal or command to the remote device 104 to offload the inference request 202 to the remote device 104.

In the event that the ML-based classifier selects the local device 102, the environment selector 114a may transmit a command to the application AI model 116a in the local device to run the model locally 214 to perform the AI task associated with the model inference request. In some embodiments, the application AI model 116b in the remote device 104 is the same as the application AI model 116a in the local device 102. In some embodiments, the application AI model 116b in the remote device 104 is a different from the application AI model 116a in the local device 102 but accomplishes the same or similar task such that the two can be used interchangeably.

Whether the model inference is executed locally 214 or remotely 212, an inference result 216 is returned by the application AI model 116. In some embodiments, the inference result 216 is returned to the local device 102 as a response to the model inference request 202. The response may include, for example, a prediction generated by the application AI model 124 based on the provided inputs 204, such as, for example, a predicted, text, image, and/or the like.

In some embodiments, the ML-based classifier 210 includes more than two classes (e.g., locally 214, remotely 212, etc.). The ML-based classifier 210 may also include one or more hybrid classes, which direct the inference request 202 to be executed partially on the local device 102 and partially on the remote device 104.

FIG. 3 depicts a data flow diagram for handling a model inference request via an environment selector 114b that a deterministic algorithm, according to one or more embodiments. The environment selector 114b may receive an inference request to perform an AI task (e.g., model inference or training request) 302 for an application AI model 116. The environment selector 114b may process the request 302 and identify one or more inputs 304 and model information 306 pertaining to the application AI model 116. In some embodiments, the inference request 302 is received at the local device 102. The one or more inputs 304 may be any of the examples described above with respect to the inputs 204 of FIG. 2. The model information 306 may include characteristics of the application AI model 116, such as described above with respect to the model information 206 of FIG. 2

In some embodiments, the inputs 304 and the model information 306 are provided to a deterministic algorithm 308. The deterministic algorithm 308 may select, based on the inputs 304, model information 206 and a set of decision rules the local device 102 the remote device 104 for executing the AI model 116.

In the event that the remote device 104 is selected for running the model remotely 310, the environment selector 114b may transmit a signal or command to the remote device 105 to run the AI model 116b in the remote device 104. All or some of the model inference request 302 (e.g., the inputs 304) may be included in the signal or command to the remote device 104 to offload the inference request 302 to the remote device 104.

In the event that the ML-based classifier selects the local device 102 for running the model locally 312, the environment selector 114b may transmit a command to the application AI model 116a in the local device to run the model locally 312 to perform the AI task associated with the model inference request. In some embodiments, the application AI model 116b in the remote device 104 is the same as the application AI model 116a in the local device 102. In some embodiments, the application AI model 116b in the remote device 104 is a different from the application AI model 116a in the local device 102 but accomplishes the same or similar task such that the two can be used interchangeably.

Whether the model inference is executed locally 312 or remotely 310, an inference result 314 is returned by the application AI model 116. In some embodiments, the inferences result 314 is returned to the local device 102 as a response to the model inference request 202. The response may include, for example, a prediction generated by the application AI model 124 based on the provided inputs 204, such as, for example, a predicted, text, image, and/or the like.

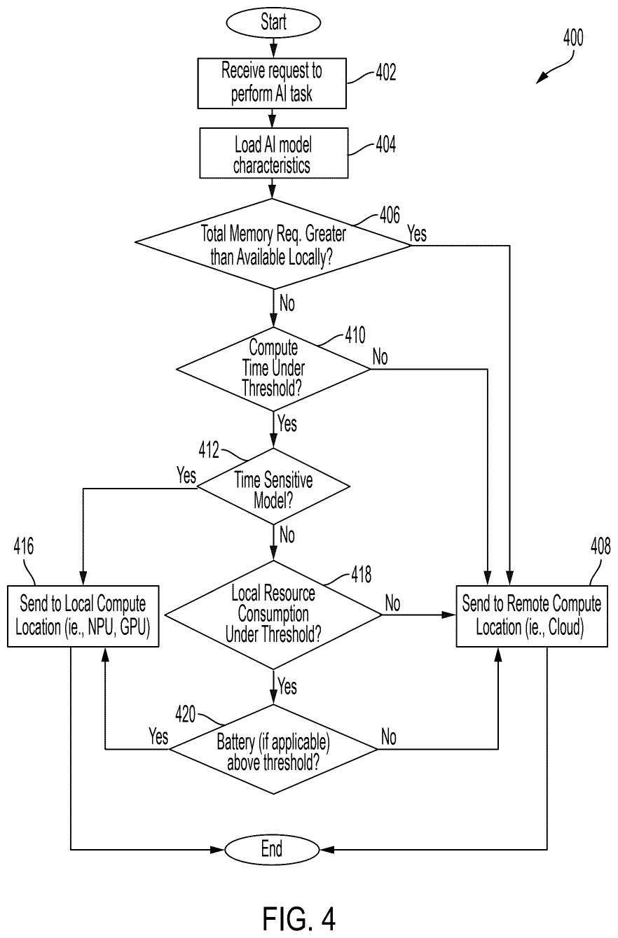

FIG. 4 depicts a flow diagram of an example process 400 for selecting an environment for executing an ML model request using the deterministic algorithm 308 of FIG. 3, according to one or more embodiments. The process 400 starts and at operation 402, a device such as local device 102 receives a request to execute an AI task (e.g., training, inference).

At operation 404, model characteristics of the application AI model 116 are loaded. The model characteristics may include the model name, number of parameters in the model, model size, model weight size, the size of an input (e.g., query) to the model, number of layers, number of nodes/operations, types of operations, memory utilized, acceptable latency, computation resource consumption, among others. In some embodiments, the model characteristics are loaded from memory device(s) 112 in the local device 102. In some embodiments, the model characteristics are obtained from an external source such as an application provider.

At operation 406, the environment selector 114b may determine whether the total memory to be utilized when performing the AI task is greater than the memory available for the AI task at the local device 102. If the total memory to be utilized when performing the AI task is greater than the memory available for the AI task at the local device 102, then the process proceeds to operation 408. If the total memory to be utilized when performing the AI task is not greater than the memory available for the AI task at the local device 102, then the process proceeds to operation 410. In some embodiments, the memory available at the local device 102 allotted for the AI task may be a percentage of the total memory available on the local device 102. For example, if executing the AI task would cause more than 90% of the total memory of the local device 102 to be used, the environment selector 114b may determine that there is insufficient memory available on the local device to perform the AI task and the process would proceed to operation 408.

At operation 408, the AI task is sent to the remote device 104 to be executed. In this regard, the environment selector 114b may transmit a signal or command to the remote device to run the AI model 116b in the remote device. All or some of the request received in operation 402 may be transmitted to the remote device 104.

At operation 410, the processor 108 determines whether the compute time for executing the AI task is below a threshold amount of time. If the compute time for executing the AI task is not below the threshold about of time (e.g., the compute time is estimated to be longer than the threshold amount of time), the process 400 proceeds to operation 408 where the AI task is sent to the remote device 104 to be executed. If the compute time for executing the AI task is below the threshold about of time (e.g., the compute time is estimated to be shorter than the threshold amount of time), the process proceeds to operation 412.

At operation 412, the processor 108 determines whether the AI task or model is time sensitive. This may be an attribute or property listed in the model characteristics. If the AI task or model is time sensitive, the process 400 proceeds to operation 416. If the AI task or model is not time sensitive, the process 400 proceeds to operation 418.

At operation 416, the AI task is sent to or kept at the local device 102 to be executed. In this regard, the environment selector 114b may transmit a command to the application AI model 116a at the local device for executing the AI task.

At operation 418, the processor 108 determines whether local resource consumption associated with performing the AI task is under a threshold amount. For example, local resources include processor (e.g., GPU) availability, or number of free cores or threads. if the local resource consumption associated with performing the AI task is not under a threshold amount. The threshold amount may be the amount of resource available on the local device 102 or the amount of resource allocated for the AI model or application. If the local resource consumption associated with performing the AI task is not under the threshold amount, the process 400 proceeds to operation 408 where the AI task is sent to the remote device 104 to be executed. If the local resource consumption associated with performing the AI task is under the threshold amount, the process 400 proceeds to operation 420.

At operation 420, the processor 108 determines whether the amount of battery life remaining in the power source 106 is above a threshold level. If the amount of battery life remaining in the power source 106 is not above the threshold level (e.g., there is not adequate battery life), the process 400 proceeds to operation 408, where the AI task is sent to the remote device 104 to be executed. If the amount of battery life remaining in the power source 106 is above the threshold level (e.g., there is adequate battery life), the process 400 proceeds to operation 416, where the AI task is sent to or kept at the local device 102 to be executed.

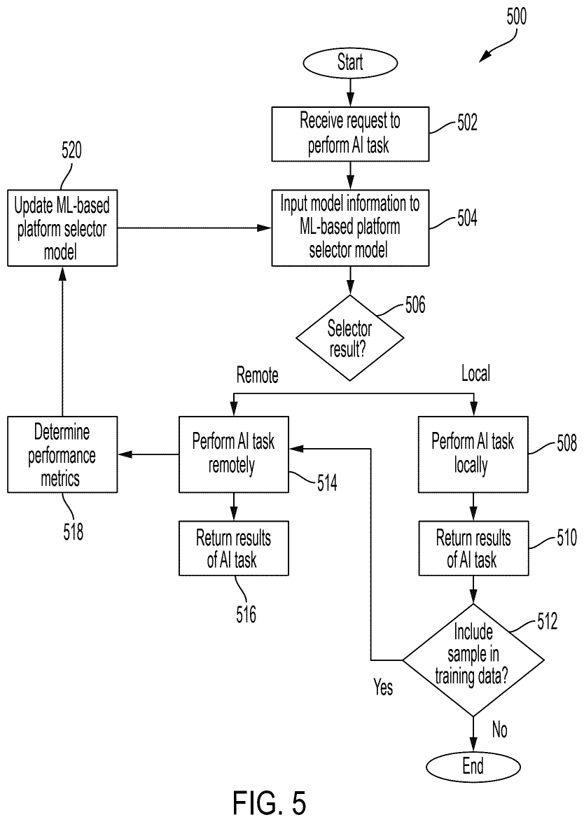

FIG. 5 depicts a flow diagram of a process 500 for training or updating an ML-based classifier such as the ML-based classifier 210 of FIG. 2, according to one or more embodiments. The process 500 starts and at operation 502, the local device 102 receives a request to perform an AI task such as to execute an application AI model 116. In some embodiments, the request includes an input 204 (e.g., query) to the application AI model 116.

At operation 504, the input 204 and model information 206 pertaining to the application AI model 116 are input to the ML-based classifier 210.

At operation 506, the ML-based classifier 210 classifies the received input to the local device 102 or the remote device 104, for respectively performing the AI task locally via the application AI model 116a on the local device, or remotely via the application AI model 116b on the remote device 104. If the ML-based classifier 210 classifies the AI task to be performed locally, the process 500 proceeds to operation 508. If the ML-based classifier 210 classifies the AI task to be performed remotely, the process 500 proceeds to operation 514.

At operation 508, the application AI model 116 at the local device 102 is invoked to perform the AI task on the input.

At operation 510, the output or result of executing the application AI model 116 on the input is returned as a response to the request.

At operation 512, the environment selector 114 determines whether to include the generated response and associated input as a training data for updating the ML-based classifier 210. If the environment selector 114 determines not to include this sample as training data, the process 500 ends. If environment selector 114 determines to include this sample as training data, the process proceeds to operation 514.

At operation 514, the application AI model 116b at the remote device 104 is used to perform the same AI task on the same input as performed by the application AI model 116 at the local device 102.

At operation 518, the environment selector 114 determines performance metrics associated with performing the AI task locally (operation 508) and performing the AI task remotely (operation 514). Example performance metrics include whether the AI task was successfully performed (e.g., a recommendation was provided by the application AI model 116) given the battery, memory, and/or processor capability of the local device 102, the total latency when performing the AI task remotely versus performing the AI task locally, amount of computing and energy resources used, and/or the like.

At operation 520, the environment selector 114 updates the ML-based classifier 210 with the input 204 and/or model information 206 and the performance metrics, in which the performance metrics serve as reinforcement data for training the ML-based classifier 210. In some embodiments, samples are selected randomly to be used as training data. In some embodiments, samples are selected based on a preset interval (e.g., every 100 requests). In some embodiments, samples are selected at dynamically scaled intervals based on the performance metrics. For example, if the performance metrics are relatively high, the sampling rate may be relatively low, as this may indicate that the ML-based classifier 210 is already performing well. Conversely, if the performance metrics are relatively low, the sampling rate may be relatively high, as this may indicate that the ML-based classifier 210 is not performing well and would benefit from additional training.

If, at operation 506, the ML-based classifier 210 classified the AI task to be performed remotely, the process 500 proceeds to operation 514 instead of operations 508, 510, and 512.

At operation 514, the application AI model 116b at the remote device 104 is used to perform the AI task on the input.

At operation 516, the output or result of executing the application AI model 116b on the input is returned as a response to the request, and the process 500 ends. In some embodiments, the response is provided to the local device 102 from the remote device 104.

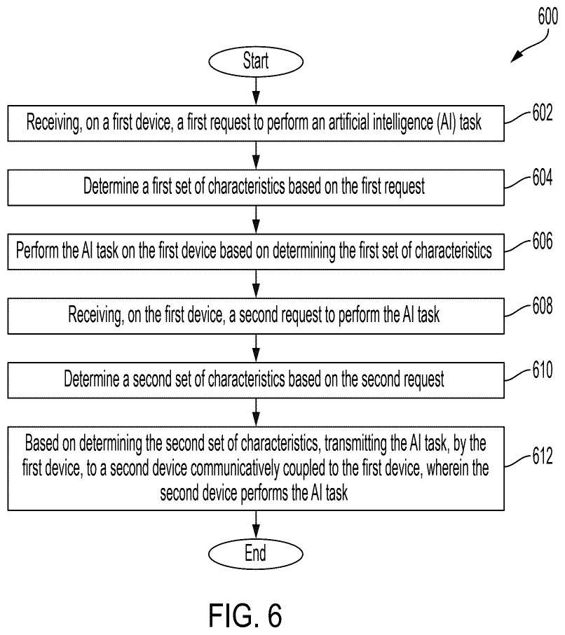

FIG. 6 depicts a flow diagram of a process 600 for handling requests to perform an AI task. The process starts and at operation 602, a first device (e.g., local device 102) receives a first request to perform an AI task.

At operation 604, the first device determines a first set of characteristics based on the first request. In some embodiments, the environment selector 114 of the local device 102 determines a first set of characteristics. In some embodiments, the first set of characteristics includes characteristics of the AI task, such as parameters associated with a maximum latency, an amount of computational resource, an amount of memory, or an amount power associated with performing the AI task. In some embodiments, one or more of the first set of characteristics are stored in the memory device 112 and are retrieved by the environment selector 114. In some embodiments, one or more of the characteristics, such as maximum latency, are obtained from metadata of the AI model 116. In some embodiments, the environment selector 114 calculates or approximates the amount of memory, power, or latency associated with performing the AI task based on the first request (e.g., length, type of request). In some embodiments, the first set of characteristics includes one or more characteristics of the first device, such as computational availability, a memory availability, a power availability, a latency, a network connectivity status, a security specification, or a hardware specification.

At operation 606, the first device performs the AI task based on determining the first set of characteristics. In some embodiments, performing the AI task on the first device includes invoking an AI model in the first device. In some embodiments, the first device selects the first device for performing the AI task based on a deterministic algorithm. In some embodiments, the first device selects the first device for performing the AI task based on an ML model.

At operation 608, the first device receives a second request to perform the AI task.

At operation 610, the first device determines a second set of characteristics based on the second request. In some embodiments, the environment selector 114 of the local device 102 determines a second set of characteristics.

At operation 612, based on determining the second set of characteristics, the first device transmits the AI task to a second device (e.g., remote device 104) to perform the AI task. In some embodiments, the second device is communicatively coupled to the first device such as via a communications network or protocol. The second device performs the AI task and returns the result to the first device. In some embodiments, transmitting the AI task by the first device to the second device includes transmitting the second request received at the first device to the second device and any other information needed by the second device to perform the AI task, such as one or more inputs to be used for the AI task. For example, the inputs may include a query for an inference task. The second request may also include a model identifier or application identifier for invoking the corresponding model at the second device. In some embodiments, transmitting the AI task includes making a third request by the first device to the second device, in which the third request includes the input (e.g., query) and other information included in the second request received at the first device.

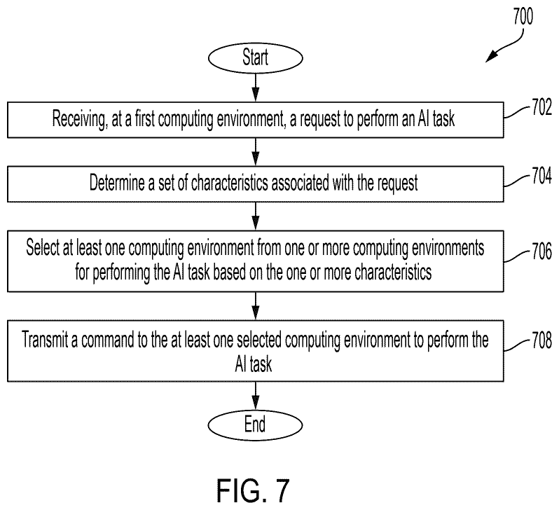

FIG. 7 depicts a flow diagram of another example process 700 for handling a request to perform an AI task according to one or more embodiments. The process starts and at operation 702, a first computing environment (e.g., local device 102) receives a request to perform an AI task.

At operation 704, the first computing environment determines a set of characteristics associated with the request. In some embodiments, the characteristics of the request include at least one of a maximum latency, an amount of computational resource, an amount of memory, or an amount power associated with performing the AI task. In some embodiments, the one or more characteristics include at least one of a computational availability, a memory availability, a power availability, a latency, a network connectivity status, a security specification, or a hardware specification of the first device.

At operation 706, an environment selector 114 at the first computing environment selects at least one computing environment from one or more computing environments for performing the AI task based on the one or more characteristics. For example, the selector model may select between the first computing environment, a second computing environment (e.g., remote device 104), or a combination of the first computing environment and a second computing environment. In some embodiments, the environment selector 114 includes an ML-based classifier 210 which takes the one or more characteristics as inputs to an ML classifier to determine whether the AI task should be performed at the first computing environment or the second computing environment. In some embodiments, the environment selector 114 includes a deterministic environment selector algorithm 308 which applies predefined logic to the one or more characteristics to determine whether the AI task should be performed at the first computing environment or the second computing environment.

At operation 708, the environment selector 114 transmits a command the at least one selected computing environment (e.g., local device 102, remote device 104) to perform the AI task.

Systems and methods of the present disclosure provide techniques for selectively offloading AI workloads from a local device 102 such as a smartphone or personal computer to a remote device 104 such as a cloud server. The selection of whether to perform an AI task at the local device 102 or offload to the remote device may be based on parameters of the particular workload as well as the conditions of the local device 102 and remote device 104 at the time of the request. One or more embodiment of the present disclosure help improve the execution of the AI task as well as other applications of the local device 102 based on real-time factors, such as latency, battery life, interruption to other functions of the local device 102, bandwidth, and the like.

Also, although the one or more modules of the present application are assumed to be separate functional units, a person of skill in the art will recognize that the functionality of the modules may be combined or integrated into a single module, or further subdivided into further sub-modules without departing from the spirit and scope of the inventive concept.

One or more embodiments of the present disclosure may be implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for selecting an environment for executing an artificial intelligence model have been specifically described and illustrated herein, many modifications and variations will be apparent to those skilled in the art. Accordingly, it is to be understood that systems and methods for selecting an environment for executing an artificial intelligence model constructed according to principles of this disclosure may be embodied other than as specifically described herein. The disclosure is also defined in the following claims, and equivalents thereof.

The systems and methods for selecting an environment for executing an artificial intelligence model may contain one or more combination of features set forth in the below statements.

Statement 1: A method comprising: receiving, at a first computing environment, a request to perform an artificial intelligence (AI) task; selecting at least one computing environment from one or more computing environments for performing the AI task based on a set of characteristics associated with the AI task; and transmitting a command to the at least one selected computing environment to perform the AI task.

Statement 2: In the method of Statement 1, wherein the one or more computing environments comprises the first computing environment and a second computing environment remote from the first computing environment, wherein the first computing environment is a local device and the second computing environment is a remote device.

Statement 3: In the method of Statements 1 or 2, wherein the set of characteristics associated with the AI task include at least one of a maximum latency, an amount of computational resource, an amount of memory, or an amount power associated with performing the AI task.

Statement 4: In the method of any of Statements 1-3, wherein the set of characteristics include at least one of a computational availability, a memory availability, a power availability, a latency, a network connectivity status, a security specification, or a hardware specification of the first computing environment.

Statement 5: A method comprising: receiving, on a first device, a first request to perform a first artificial intelligence (AI) task; determining a first set of characteristics based on the first request; performing the AI task on the first device based on determining the first set of characteristics; receiving, on the first device, a second request to perform a second AI task; determining a second set of characteristics based on the second request; and based on determining the second set of characteristics, transmitting by the first device to a second device communicatively coupled to the first device, information on the second AI task to signal the second device to perform the second AI task.

Statement 6: In the method of any of Statement 5, wherein the first set of characteristics includes one or more characteristics of the first AI task and the second set of characteristics includes one or more characteristics of the second AI task.

Statement 7: In the method of any of Statement 5 or 6, wherein the first set of characteristics include parameters associated with at least one of a maximum latency, an amount of computational resource, an amount of memory, or an amount power associated with performing the first AI task.

Statement 8: In the method of any of Statements 5-7, wherein the first set of characteristics and the second set of characteristics include one or more characteristics of the first device.

Statement 9: In the method of any of Statements 5-8, wherein the one or more characteristics of the first device include at least one of a computational availability, memory availability, power availability, latency, network connectivity status, security specification, or hardware specification.

Statement 10: In the method of any of Statements 5-9, wherein performing the first AI task on the first device includes invoking an AI model in the first device.

Statement 11: In the method of any of Statements 5-10, further comprising: selecting, using a deterministic algorithm, the first device to perform the first AI task.

Statement 12: In the method of any of Statements 5-11, further comprising: selecting, using a machine learning (ML) model, the first device to perform the first AI task.

Statement 13: A system comprising: a processing circuit; and a memory storing instructions, which, based on being executed by the processing circuit, cause the processing circuit to perform: receiving, on a first device, a first request to perform a first artificial intelligence (AI) task; determining a first set of characteristics based on the first request; performing the AI task on the first device based on determining the first set of characteristics; receiving, on the first device, a second request to perform a second AI task; determining a second set of characteristics based on the second request; and based on determining the second set of characteristics, transmitting by the first device to a second device communicatively coupled to the first device, information on the second AI task to signal the second device to perform the second AI task.

Statement 14: In the system of Statement 13, wherein the first set of characteristics includes one or more characteristics of the first AI task and the second set of characteristics includes one or more characteristics of the second AI task.

Statement 15: In the system of Statements 13 or 14, wherein the first set of characteristics include parameters associated with at least one of a maximum latency, an amount of computational resource, an amount of memory, or an amount power associated with performing the first AI task.

Statement 16: In the system of any of Statements 13-15, wherein the first set of characteristics and the second set of characteristics include one or more characteristics of the first device.

Statement 17: In the system of any of Statements 13-16, wherein the one or more characteristics of the first device include at least one of a computational availability, memory availability, power availability, latency, network connectivity status, security specification, or hardware specification.

Statement 18: In the system of any of Statements 13-17, wherein performing the first AI task on the first device includes invoking an AI model in the first device.

Statement 19: In the system of any of Statements 13-18, wherein the instructions, based on being executed by the processing circuit, further cause the processing circuit to perform: selecting, using a deterministic algorithm, the first device to perform the first AI task.

Statement 20: In the method of any of Statements 13-19, wherein the instructions, based on being executed by the processing circuit, further cause the processing circuit to perform: selecting, using a machine learning (ML) model, the first device to perform the first AI task.

What is claimed is:

1. A method comprising:
receiving, at a first computing environment, a request to perform an artificial intelligence (AI) task;
selecting at least one computing environment from one or more computing environments for performing the AI task based on a set of characteristics associated with the AI task; and
transmitting a command to the at least one selected computing environment to perform the AI task.

2. The method of claim 1, wherein the one or more computing environments comprises the first computing environment and a second computing environment remote from the first computing environment, wherein the first computing environment is a local device and the second computing environment is a remote device.

3. The method of claim 1, wherein the set of characteristics associated with the AI task include at least one of a maximum latency, an amount of computational resource, an amount of memory, or an amount power associated with performing the AI task.

4. The method of claim 1, wherein the set of characteristics include at least one of a computational availability, a memory availability, a power availability, a latency, a network connectivity status, a security specification, or a hardware specification of the first computing environment.

5. A method comprising:
receiving, on a first device, a first request to perform a first artificial intelligence (AI) task;
determining a first set of characteristics based on the first request;
performing the AI task on the first device based on determining the first set of characteristics;
receiving, on the first device, a second request to perform a second AI task;
determining a second set of characteristics based on the second request; and
based on determining the second set of characteristics, transmitting by the first device to a second device communicatively coupled to the first device, information on the second AI task to signal the second device to perform the second AI task.

6. The method of claim 5, wherein the first set of characteristics includes one or more characteristics of the first AI task and the second set of characteristics includes one or more characteristics of the second AI task.

7. The method of claim 5, wherein the first set of characteristics include parameters associated with at least one of a maximum latency, an amount of computational resource, an amount of memory, or an amount power associated with performing the first AI task.

8. The method of claim 5, wherein the first set of characteristics and the second set of characteristics include one or more characteristics of the first device.

9. The method of claim 8, wherein the one or more characteristics of the first device include at least one of a computational availability, memory availability, power availability, latency, network connectivity status, security specification, or hardware specification.

10. The method of claim 5, wherein performing the first AI task on the first device includes invoking an AI model in the first device.

11. The method of claim 5, further comprising:
selecting, using a deterministic algorithm, the first device to perform the first AI task.

12. The method of claim 5, further comprising:
selecting, using a machine learning (ML) model, the first device to perform the first AI task.

13. A system comprising:
a processing circuit; and
a memory storing instructions, which, based on being executed by the processing circuit, cause the processing circuit to perform:
receiving, on a first device, a first request to perform a first artificial intelligence (AI) task;
determining a first set of characteristics based on the first request;
performing the AI task on the first device based on determining the first set of characteristics;
receiving, on the first device, a second request to perform a second AI task;
determining a second set of characteristics based on the second request; and
based on determining the second set of characteristics, transmitting by the first device to a second device communicatively coupled to the first device, information on the second AI task to signal the second device to perform the second AI task.

14. The system of claim 13, wherein the first set of characteristics includes one or more characteristics of the first AI task and the second set of characteristics includes one or more characteristics of the second AI task.

15. The system of claim 13, wherein the first set of characteristics include parameters associated with at least one of a maximum latency, an amount of computational resource, an amount of memory, or an amount power associated with performing the first AI task.

16. The system of claim 13, wherein the first set of characteristics and the second set of characteristics include one or more characteristics of the first device.

17. The system of claim 16, wherein the one or more characteristics of the first device include at least one of a computational availability, memory availability, power availability, latency, network connectivity status, security specification, or hardware specification.

18. The system of claim 13, wherein performing the first AI task on the first device includes invoking an AI model in the first device.

19. The system of claim 13, wherein the instructions, based on being executed by the processing circuit, further cause the processing circuit to perform:
selecting, using a deterministic algorithm, the first device to perform the first AI task.

20. The method of claim 13, wherein the instructions, based on being executed by the processing circuit, further cause the processing circuit to perform:
selecting, using a machine learning (ML) model, the first device to perform the first AI task.
